(19) United States
(12) Patent Application Publication
(10) Pub. No.: US 2014/0035945 A1
(43) Pub. Date: Feb. 6, 2014

(54) COMPUTING DEVICE APPLICATIONS WITH AN AUTOMATICALLY ADAPTING USER INTERFACE

(71) Applicants: Todd Anglin, The Woodlands, TX (US); Alexander Alexandrov Gyoshev, Sofia (BG); Kamen Todorov Bandev, Sofia (BG)

(72) Inventors: Todd Anglin, The Woodlands, TX (US); Alexander Alexandrov Gyoshev, Sofia (BG); Kamen Todorov Bandev, Sofia (BG)

(21) Appl. No.: 13/566,161

(22) Filed: Aug. 3, 2012

(51) Int. Cl. G09G 5/00

(52) U.S. Cl. 345/619

(57) ABSTRACT

In one aspect, the present disclosure describes a method that may include determining, by a processor of a computing device, a platform of the computing device. Based at least in part upon the platform, the method may include altering, by the processor, a platform-independent presentation file. The method may include determining, by the processor, a platform-specific graphical user interface of a software application based at least in part on the platform-independent presentation file.

### BACKGROUND

Computing devices may include, in some examples, personal computers, laptop computers, cellular phones, smart phones, personal digital assistants, portable multimedia players, electronic gaming devices, and tablet computers. Software applications may be downloaded to run on a computing device. In some implementations, Web-based application stores may provide device-specific, platform-specific, or operating system-specific software application downloads to computing devices.

### SUMMARY

In one aspect, the present disclosure describes a method that may include determining, by a processor of a computing device, a device profile of the computing device, and accessing, by the processor, a number of user interface styles. Each user interface style of the number of user interface styles may correspond to a respective device profile of a number of device profiles. The number of device profiles may include the device profile. The method may include identifying, by the processor, a first user interface style of the number of user interface styles, where the first user interface style is identified based in part upon at least a portion of the device profile of the computing device. The method may include applying, by the processor, the first user interface style to a first presentation file of one or more presentation files to determine a first platform-specific presentation file, where an application installed upon the computing device includes the one or more presentation files, and the one or more presentation files define a portion of a graphical user interface. The method may include interpreting, by the processor, at least a portion of the first platform-specific presentation file. Based upon interpretation of at least a portion of the first platform-specific presentation file, the method may include altering one or more features of a graphical element of the graphical user interface, where the one or more features of the graphical element are altered based in part upon the first interface style. The method may include rendering, to a display, the graphical user interface.

The one or more features of the graphical element may include at least one of size, color, and position. Applying the first user interface style to the first presentation file may include including a library in the first presentation file.

The method may further include detecting, by the processor, an orientation of the computing device, where the first user interface style is identified further based in part upon the orientation of the computing device. The method may further include determining, by the processor, a change in the orientation of the computing device, and identifying by the processor, a second user interface style of the number of user interface styles. The second user interface style may be identified based in part upon (a) at least a portion of the device profile of the computing device, and (b) the change in the orientation. The method may further include applying, by the processor, the second user interface style to the first presentation file to determine a second platform-specific presentation file, and interpreting, by the processor, the second platform-specific presentation file to render the graphical user interface of the application to the display.

The device profile may include an operating system. The first presentation file may include a markup language file. The markup language file may include one or more platform-independent statements. Applying the first user interface style to the first presentation file may include amending one or more statements of the markup language file, where the one or more statements are identified, in part, by the one or more platform-independent statements.

The first user interface style may include a style sheet file. The graphical element may include an image file, and altering the one or more features of the graphical element may include executing runtime-interpretable instructions to alter rendering of the image file.

Determining the device profile may include executing runtime-interpretable instructions, where an interpretation language file includes the runtime-interpretable instructions. The application may include the interpretation language file. The application may include the number of user interface styles.

In one aspect, the present disclosure describes a method that may include determining, by a processor of a computing device, a device platform of the computing device, and applying, by the processor, a first interface style to a presentation file to determine a platform-specific presentation file. An application installed upon the computing device may include the presentation file, and the presentation file may include a number of runtime-interpretable statements, where the number of runtime-interpretable statements include one or more platform-independent statements and one or more override statements. Applying the first interface style to the presentation file may include identifying a first platform-independent statement of the one or more platform-independent statements. Responsive to identifying the first platform-independent statement, applying the first interface style to the presentation file may include applying a platform-specific style feature to a first graphical element, and identifying a first override statement of the one or more override statements, where the first override statement includes at least a first override platform. Responsive to identifying the first override platform as the device platform of the computing device, applying the first interface style to the presentation file may include maintaining one or more override style features, where the one or more override style features are associated with a second graphical element. The method may include interpreting, by the processor, at least a portion of the platform-specific presentation file, where the platform-specific presentation file defines a portion of a graphical user interface. The method may include rendering, to a display, the graphical user interface.

The platform-specific style feature and the one or more override style features each may include one or more of a size, position, and color.

In one aspect, the present disclosure describes a method that may include determining, by a processor of a computing device, a platform of the computing device. Based at least in part upon the platform, the method may include altering, by the processor, a platform-independent presentation file. The method may include determining, by the processor, a platform-specific graphical user interface of a software application based at least in part on the platform-independent presentation file.

Altering the platform-independent presentation file may further include applying, by the processor, a platform-specific user interface style to the platform-independent presentation file. The platform-independent presentation file may include a statement that identifies a graphical element of the graphical user interface. The platform-specific user interface style may include a property to apply to the graphical element.

The platform-independent presentation file may further include an override statement. The method may further include maintaining, without modification, a second property to apply to a second graphical element based at least in part on the override statement.

The method may further include determining an orientation of the computing device. Altering the platform-independent presentation file may further include altering the platform-independent presentation based at least in part on the orientation.

The method may further include rendering, by the processor, the platform-specific graphical user interface to a display. The property may include at least one of a position, a layout, a control property, a size, a font setting, and a background setting.

In one aspect, the present disclosure describes a system that may include a processor and a memory storing instruction thereon. The instructions when executed may cause the processor to determine a device profile of a computing device, and access a number of user interface styles, where each user interface style of the number of user interface styles corresponds to a respective device profile of a number of device profiles, and where the number of device profiles includes the device profile. The instructions when executed may cause the processor to identify a first user interface style of the number of user interface styles, where the first user interface style is identified based in part upon at least a portion of the device profile of the computing device. The instructions when executed may cause the processor to apply the first user interface style to a first presentation file of one or more presentation files to determine a first platform-specific presentation file. An application installed upon the computing device may include the one or more presentation files. The one or more presentation files may define a portion of a graphical user interface. The instructions when executed may cause the processor to interpret at least a portion of the first platform-specific presentation file, and based upon interpretation of at least the portion of the first platform-specific presentation file, alter one or more features of a graphical element of the graphical user interface. The one or more features of the graphical element may be altered based in part upon the first interface style. The instructions when executed may cause the processor to render, to a display, the graphical user interface.

The computing device may include the processor.

In one aspect, the present disclosure describes a non-transitory computer readable medium having instructions stored thereon that, when executed, cause a processor to determine a device profile of a computing device, and access a number of user interface styles, where each user interface style of the number of user interface styles corresponds to a respective device profile of a number of device profiles, and where the number of device profiles includes the device profile. The instructions, when executed, may cause the processor to identify a first user interface style of the number of user interface styles, where the first user interface style is identified based in part upon at least a portion of the device profile of the computing device. The instructions, when executed, may cause the processor to apply the first user interface style to a first presentation file of one or more presentation files to determine a first platform-specific presentation file. An application installed upon the computing device may include the one or more presentation files, and the one or more presentation files may define a portion of a graphical user interface. The instructions, when executed, may cause the processor to interpret at least a portion of the first platform-specific presentation file. Based upon interpretation of at least the portion of the first platform-specific presentation file, the instructions, when executed, may cause the processor to alter one or more features of a graphical element of the graphical user interface, where the one or more features of the graphical element are altered based in part upon the first interface style. The instructions, when executed, may cause the processor to render, to a display, the graphical user interface.

The computing device may include the processor.

In one aspect, the present disclosure describes a system that may include a processor and a memory storing instruction thereon. The instructions when executed may cause the processor to determine a device platform of a computing device, and apply a first interface style to a presentation file to determine a platform-specific presentation file. An application installed upon the computing device may include the presentation file, and the presentation file may include a number of runtime-interpretable statements. The number of runtime-interpretable statements may include one or more platform-independent statements and one or more override statements. Applying the first interface style to the presentation file may include identifying a first platform-independent statement of the one or more platform-independent statements, and, responsive to identifying the first platform-independent statement, applying a platform-specific style feature to a first graphical element. Applying the first interface style to the presentation file may include identifying a first override statement of the one or more override statements, where the first override statement includes at least a first override platform. Responsive to identifying the first override platform as the device platform of the computing device, applying the first interface style to the presentation file may include maintaining one or more override style features, where the one or more override style features are associated with a second graphical element. The instructions when executed may cause the processor to interpret at least a portion of the platform-specific presentation file, where the platform-specific presentation file defines a portion of a graphical user interface. The instructions when executed may cause the processor to render, to a display, the graphical user interface.

In one aspect, the present disclosure describes a non-transitory computer readable medium having instructions stored thereon that, when executed, cause a processor to determine a device platform of a computing device, and apply a first interface style to a presentation file to determine a platform-specific presentation file. An application installed upon the computing device may include the presentation file. The presentation file may include a number of runtime-interpretable statements, where the number of runtime-interpretable statements may include one or more platform-independent statements and one or more override statements. Applying the first interface style to the presentation file may include identifying a first platform-independent statement of the one or more platform-independent statements, and, responsive to identifying the first platform-independent statement, applying a platform-specific style feature to a first graphical element. Applying the first interface style to the presentation file may include identifying a first override statement of the one or more override statements, where the first override statement includes at least a first override platform. Responsive to identifying the first override platform as the device platform of the computing device, applying the first interface style to the presentation file may include maintaining one or more override style features, where the one or more override style features are associated with a second graphical element. The instructions, when executed, may cause the processor to interpret at least a portion of the platform-specific presentation file, where the platform-specific presentation file defines a portion of a graphical user interface. The instructions, when executed, may cause the processor to render, to a display, the graphical user interface.

In one aspect, the present disclosure describes a system that may include a processor and a memory storing instruction thereon. The instructions when executed may cause the processor to determine a platform of a computing device, where the computing device includes the processor. Based at least in part upon the platform, the instructions when executed may cause the processor to alter a platform-independent presentation file. The instructions when executed may cause the processor to determine a platform-specific graphical user interface of a software application based at least in part on the platform-independent presentation file.

In one aspect, the present disclosure describes a non-transitory computer readable medium having instructions stored thereon that, when executed, may cause a processor to determine a platform of a computing device, where the computing device includes the processor. Based at least in part upon the platform, the instructions when executed may cause the processor to alter a platform-independent presentation file. The instructions when executed may cause the processor to determine a platform-specific graphical user interface of a software application based at least in part on the platform-independent presentation file.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a system diagram illustrating a software development environment that may be used for creating and distributing applications for computing devices;

FIG. 2 is a flow chart illustrating an example method that may be used for developing software applications for computing devices;

FIG. 3 is a flow chart illustrating an example method for executing a software application upon a computing device;

FIGS. 4A through 4E illustrate example pseudocode and corresponding example user interfaces;

FIG. 5 is a flow chart illustrating an example method for applying platform-specific styles to a platform-independent presentation file;

FIG. 6 is a block diagram of an example network environment for creating applications for computing devices;

FIG. 7 is a block diagram of an example computing device and an example mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed to environments and methods for development of software for computing devices. The development process, in some implementations, may include development of a computing device application with an automatically adapting user interface for deployment on two or more computing device platforms. A computing device platform, in some examples, may refer to a particular set of configuration parameters such as one or more of a device operating system (e.g., Microsoft® Windows® by Microsoft Corporation of Redmond, Wash., Linux™, Apple® Mac™ OS by Apple Inc. of Cupertino, Calif., Research in Motion (RIM) Blackberry® OS by Research in Motion Limited of Waterloo, Ontario, etc.), a device application format (e.g., Apple® iOS™ by Apple Inc., Android™ by Google Inc. of Menlo Park, Calif., Windows® Phone by Microsoft Corporation, Palm™ webOS™ by Hewlett-Packard Company of Palo Alto, Calif., Symbian™ by Accenture PLC of Dublin, Ireland, Bada™ by Samsung Electronics of Seoul, S. Korea, etc.), and a device peripheral configuration (e.g., input and output devices such as, in some examples, sensors, speakers, microphones, virtual and/or miniaturized keyboard, buttons and other physical control inputs, etc.).

As described herein, an application development environment (ADE), in some implementations, may provide an interface for developing a computing device application with an automatically adapting user interface that may apply adjustments, at runtime, to modify user interface elements for display based upon a particular computing device platform. During development, for example, platform-independent constructs and widgets may be employed to design the user interface. As used herein, the term platform-independent relates to information that may be applied to two or more computing device platforms. In some implementations, an ADE may include features for designing, constructing, compiling, testing, and/or distributing software applications for a number of computing device platforms. The ADE, in some implementations, may provide a developer with a development environment for generating user interface elements of a computing device application that is removed from individual software development kits (SDKs) or integrated development environments (IDEs) (e.g., xCode™ by Apple, Inc., Eclipse by the Eclipse Foundation of Ottawa, Canada, Visual Studio® by Microsoft Corporation, Rational Application developer for WebSphere® software by International Business Machines Corporation (IBM) of Armonk, N.Y., etc.) and/or programming languages (e.g., Objective-C, Java, C#, etc.) typically used for developing software applications for various platforms of computing devices. In some implementations, an ADE for development of a computing device application with an automatically adapting user interface may involve an application developer interface installed on a local development computing device for developing and simulating the computing device application. The application developer interface, in some implementations, may provide the developer with a communication channel to a network environment (e.g., local area network (LAN), wide area network (WAN), Internet, Cloud, etc.) including automatically adaptive user interface development tools, such as, in some examples, one or more software libraries, one or more widgets, and/or one or more computing device profiles.

In some implementations, development of a computing device application with an automatically adapting user interface may be enabled through an abstraction layer that allows the user interface of an application to be defined primarily through non-compiled resource files (e.g., “presentation files” as used herein). The non-compiled resource files may include, in some examples, markup languages such as HyperText Markup Language (HTML), HTML5, or XHTML by the World Wide Web Consortium (W³C) and Web Hypertext Application Technology Working Group (WHATWG), interpreted languages such as JavaScript™ by Netscape Communications Corp of Mountain View, Calif., and style sheet languages such as Cascading Style Sheets (CSS) by the W³C. The non-compiled resource files, in some implementations, may include mechanisms that enable runtime configuration of computing device profile-specific styles such as, in some examples, font settings, color settings, user interface element positions, icon sizings, and icon styles. In some implementations, the non-compiled resource files may include graphic files that are capable of dynamic rendering by an interpreting application, such as Scalable Vector Graphics (SVG) or Vector Markup Language (VML). The dynamically renderable graphics files may be automatically adjusted prior to rendering to a display to adjust, in some examples, one or more of size, shape, opacity, and outline. In some implementations, the non-compiled resource files may further include commands for interacting with device configuration settings or Web-based services such as device or platform-specific application programming interfaces (APIs).

The non-compiled resource files, in some implementations, may be interpreted at run-time on the computing device to enable interactions between a user and the computing device. In some implementations, the non-compiled resource files may be interpreted by a browser engine feature of the computing device. In some implementations, the non-compiled resource files may be provided for presentation in a “windowless” (e.g., full screen, without defining browser border, etc.) web-browser interface rendered upon the computing device. In some implementations, the non-compiled resource files may be combined with a number of media files, such as audio, image, and video files, that may be accessed and presented during execution of the application. The media files, for example, may be accessed through links to the media files incorporated in the non-compiled resource files. The combination of the media files and the non-compiled resource files, in some implementations, may be referred to as the “content files” of a computing device application development project.

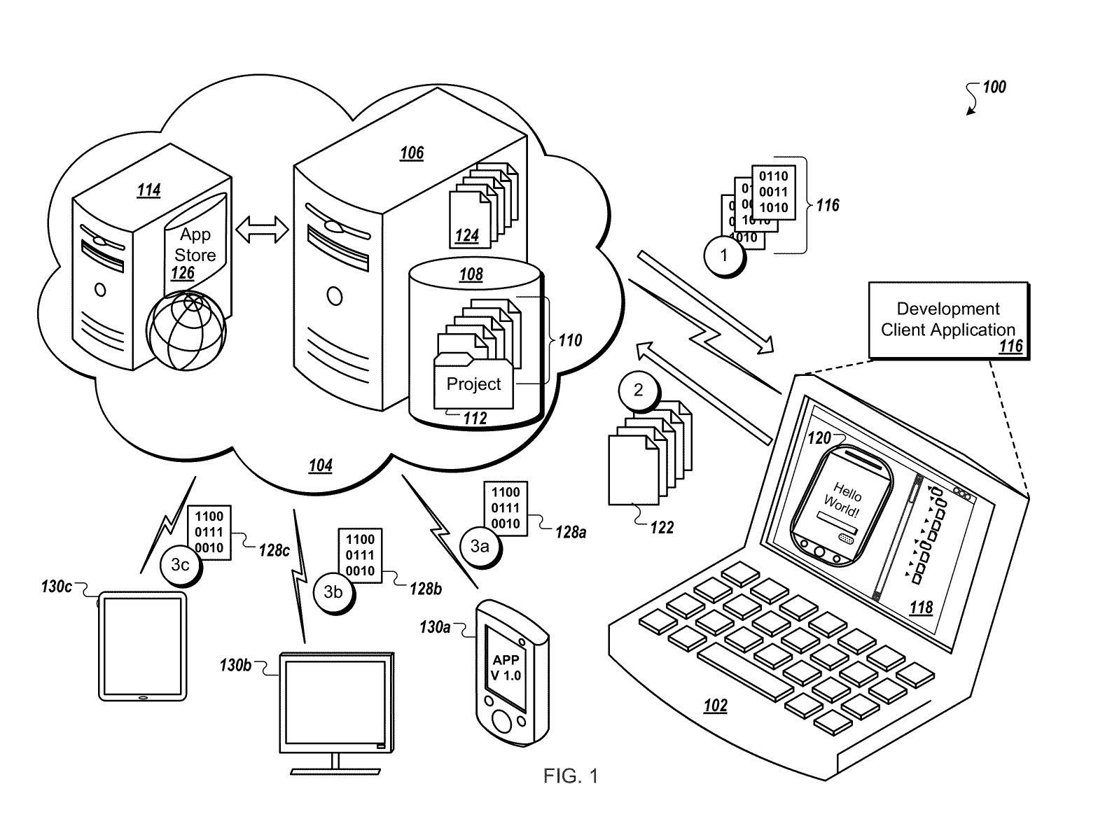

FIG. 1, in some implementations, may illustrate a network development environment 100 for developing and distributing computing device applications for deployment to a number of computing devices including two or more device platforms. Turning to FIG. 1, the development environment 100 may include a development computing device 102 (e.g., laptop computer, desktop computer, tablet computer, notebook computer, or other computing device configurable for software development purposes) in communication with a network 104. The network 104, in some implementations, may include a development server 106 for development of computing device applications, a project repository 108 for storing project files 110 (e.g., content files and other files) related to a computing device application project as collected, for example, in a project directory 112, and a web server 114 for distribution of computing device applications.

To begin development of a computing device application, in some implementations, a developer may first download and install a development client application 116 to the development computing device 102. The development client application 116, in some examples, may be downloaded from the network 104 (e.g., as illustrated), downloaded through another network (e.g., via a Web browser or Web-based application store, etc.) or installed via a removable computer-readable medium accessible to the development computing device 102 such as, in some examples, a compact disk (CD), digital video disk (DVD), or Universal Serial Bus (USB) memory device.

In some implementations, the development client application 116 may enable local presentation of a development interface 118 on the development computing device 102. The development client application 116, in some implementations, may include features or include access to network-based features for programming and debugging a computing device application using non-compiled resource files and other (e.g., media, meta data, etc.) files via the development interface 118. In some implementations, the development server 106 may enable a development environment interface between the development computing device 102 and the network 104. For example, the development client application 116 may interface with the development server 106 over the network 104 to gain access to one or more features of the application development environment.

In some implementations, the application development environment may supply the development client application 116 with access to network-based development tools such as adaptive user interface libraries and widgets 124 for developing a computing device application with an automatically adapting user interface. The adaptive user interface libraries and widgets 124, for example, may include one or more platform-specific interface styles that may be applied, at runtime, to a non-compiled resource file. Upon application of the one or more platform-specific interface styles, for example, platform-independent user interface features may be automatically adapted to the computing device platform or device profile prior to rendering the user interface of the computing device application executing on a computing device. In this manner, for example, a computing device application may be designed once, having the ability to automatically adapt to the look and feel of a native platform environment. In some implementations, a platform-independent application design may be linked to a set of layout styles that reflect the style of particular computing device platforms (e.g., iPhone® platforms by Apple, Inc. of Cupertino, Calif., Android™ platforms by Google, Inc. of Mountain View, Calif., Blackberry® platforms by Research in Motion of Ontario, Calif., etc.). In one example, a series of widgets (e.g., specialized HTML5 tags, JavaScript™ calls, etc.) may provide the connection between platform-independent application instructions and platform-specific layouts. In some implementations, a platform-independent computing device application may determine the current platform environment and adapt the user interface design at runtime. In a particular example, a browser engine rendering the platform-independent application may include a construct for determining the computing device platform.

In some implementations, the adaptive user interface libraries and widgets 124 may include mechanisms that enable runtime configuration of computing device profile-specific styles. Computing device profile-specific styles, in some examples, may include font settings (e.g., style, size, opacity, color, etc.), background settings (e.g., color, image, borders, etc.), user interface element positions (e.g., navigation bar, header, footer, search field, etc.), white space definitions (e.g., margin, line spacing, etc.), and visual indicator appearance (e.g., icon sizings, icon opacity, icon styles, scroll bar styles, etc.).

In some implementations, the interface libraries and widgets 124 may include platform-independent application programming interfaces (APIs) for creating platform-independent non-compiled resource files. For example, one or more non-compiled resource files may include platform-independent commands for rendering a user interface. As used herein, a platform-independent command refers to an instruction, markup language tag, markup attribute, runtime interpretable statement, code marker, comment style, or other uniquely identifiable character string capable of being identified as flagging a portion of a non-compiled resource file as qualifying for platform-specific manipulation. At runtime, the platform-independent commands, in some implementations, may be linked to one or more platform-specific user interface layout or style instructions. The platform-independent commands, for example, may be correlated to platform-specific layout instructions via mechanisms built in via the interface libraries and widgets 124.

In some examples, the interface libraries and widgets 124 may include instructions for adjusting one or more of font settings (e.g., style, size, opacity, color, etc.), background settings (e.g., color, image, borders, etc.), user interface element positions (e.g., navigation bar, header, footer, search field, etc.), white space definitions (e.g., margin, line spacing, etc.), and visual indicator appearance (e.g., icon sizings, icon opacity, icon styles, scroll bar styles, etc.), and visibility (e.g., off screen, blinking, etc.) of a graphical element (e.g., text, user interface element, visual indicator, etc.). The adjustments, in some implementations, may be based in part upon one or more of device display dimensions, device display resolution, and device display color depth. In some implementations, the adjustments may be based in part upon operating system standard styles such as, in some examples, color schemes, system fonts, interface control styles, and interface control layouts. For example, a particular operating system may present information using a particular touch screen control layout, a particular title sizing and placement, and a particular margin setting.

Upon development of a computing device application with an automatically adapting user interface, the developer may wish to test the computing device application upon a number of different device platforms. In some implementations, the development client application 116 may further include features or include access to network-based features (e.g., provided via the development server 106) for simulating a computing device application upon two or more computing device platforms via the development interface 118. For example, a first device simulator with a first screen size and first peripheral and control features may be presented to simulate a first device platform (e.g., such as a device simulator 120 presented in the development interface 118), and a second device simulator with a second screen size and second peripheral and control features may be presented to simulate a second device platform.

Once a developer is pleased with the performance of the simulated application, in some implementations, the developer may upload any locally-stored project files 122 (e.g., presentation files, media files, etc.) to the project repository 108 where they may be stored, for example, as a portion of the project files 110 in the project directory 112. In some implementations, the development client application 116 may replicate and/or maintain one or more of the project files 122 in the project repository 108 during development of the computing device application. For example, upon saving a file, the development client application 116 may initiate upload of the new or modified file to the project repository 108.

In some implementations, the project files 122 may remain local to the development computing device 102. In some implementations, an application executable may be compiled upon the development computing device 102, for example using a computing device platform-specific software development kit or another application capable of preparing an executable file for a computing device. In some implementations, the application may be deployed as a web application, for example for execution within a browser application installed upon a computing device.

From the project repository 108, in some implementations, the project files 110 may be compiled to create an application executable file. In some implementations, the development client application 116 may upload target computing device information including, in some examples, a device brand, model, operating system, operating system version, or unique device identifier. The development client application 116, in some implementations, may upload developer information such as, in some implementations, demographic information regarding the developer (e.g., name, contact information, etc.) and a certificate of authentication as provided by a signing authority, such as a signing authority corresponding to a particular computing device platform. One or more versions (e.g., platform-specific versions) of a computing device application may be generated based upon the uploaded information.

The network environment 100, in some implementations, may further include a set of target computing devices 130 such as a smart phone 130a, a smart television 130b, and a tablet computer 130c. As illustrated, each of the target computing devices 130 is in wireless communication with the network 104. As illustrated, in some implementations, a set of platform-specific application files 128 may be downloaded to the respective computing devices 130 from the network 104. In some implementations, the application files 128 may each be tailored to a particular platform of each respective target computing device 130. In other implementations, a platform-independent application file 128 may be provided to one or more of the target computing devices 130.

In some implementations, the application files 128 may include one or more runtime-executable files. For example, rather than compiling the application files 128, the application files 128 may be compressed, bundled, or otherwise prepared for provision to one or more of the target computing devices 130. In some implementations, the runtime-executable files may be downloaded to a browser application installed upon one of the target computing devices 130 for performance as a web application.

In some implementations, the application files 128 may be downloaded to the respective target computing devices 130 via the web server 114. In one example, bundled application files 128 may be downloaded by a browser application running on a respective target computing device 130 via the web server 114. In a second example, upon generation of one of the application files 128, the particular application executable file 128 may be stored within an application store 126. Upon request by a particular target computing device 130, the web server 114 may provide the respective application executable file 128 from the application store 126. The application store 126, for example, may include one or more storage devices in communication with the web server 114. Although illustrated as separate devices, in some implementations the development server 106 may include the web server 114. In some implementations, the web server 114 may be included in a separate network than the network 104. For example, the network 104 may be a cloud computing network for providing a development environment, while the web server 114 may provide access to a commercial application store for selecting, purchasing, and downloading wireless computing device applications.

Although illustrated as being downloaded to the target computing devices 130 from the network 104, in some implementations, the platform-specific application files 128 may be downloaded to one or more of the target computing devices 130 directly from the development computing device 102. For example, via a wireless or wired connection, one of the application files 128 may be downloaded to one of the target computing devices 130.

In some implementations, the application files 128 may include an installation executable for installing a computing device application with an automatically adapting user interface. The application files 128, in some implementations, may include a set of presentation files for rendering an automatically adapting user interface within an application executable already installed upon a particular target computing device 130. For example, the application files 128 may include one or more presentation files for rendering a user interface within a browser application.

Upon execution of the application upon the target computing devices 130, in some implementations, project files 122 included within the application files 128 may include presentation files such as, in some examples, markup language files (e.g., HyperText Markup Language (HTML), HTML5, or XHTML), interpreted language files (e.g., JavaScript™), and style sheet language files (e.g., Cascading Style Sheets (CSS)). The presentation files, in some implementations, may include platform-independent calls, widgets, or commands that enable runtime configuration of profile-specific user interface layout styles such as, in some examples, font settings (e.g., style, size, opacity, color, etc.), background settings (e.g., color, image, borders, etc.), user interface element positions (e.g., navigation bar, header, footer, search field, etc.), white space definitions (e.g., margin, line spacing, etc.), and visual indicator appearance (e.g., icon sizings, icon opacity, icon styles, scroll bar styles, etc.). In some implementations, the presentation files may further include calls, widgets, or commands for interacting with device configuration settings or Web-based services such as device or platform-specific application programming interfaces (APIs). For example, one or more presentation files may include commands for querying the target computing device 130 rendering the presentation file for platform-specific information.

In some implementations, the calls, widgets, or commands may interface the presentation file with interface libraries and widgets 124 that may have been included in the application file 128. For example, the interface libraries and widgets 124 may include platform-specific style information, device-level calls, and other platform-specific information.

The presentation files, in some implementations, may be interpreted at run-time on the target computing device 130 to enable interactions between a user and the target computing device 130. In some implementations, the presentation files may be interpreted by a browser engine feature of the target computing device 130. In some implementations, the presentation files may be provided for presentation in a “windowless” (e.g., full screen, without defining browser border, etc.) web-browser interface rendered upon the target computing device 130. In some implementations, the presentation files may be combined with a number of additional project files 110 such as, in some examples, meta data, audio, image, and video files, that may be accessed and rendered for presentation during execution of the application. For example, media files such as audio, image, and video files, may be accessed via through links to the media files incorporated in the presentation files.

In some implementations, at run time, one or more links may be established within a presentation file. For example, a platform-specific library may be linked to the presentation file based upon a determination of a particular device platform of the target computing device 130. In another example, an SVG graphic file may be altered at runtime to mimic the style of icon used in a particular device platform. The altered SVG graphic file may be linked to a presentation file at run time.

A developer, in some implementations, may test the application files 128 upon the target computing devices 130, for example to verify that the functionality matches the functionality observed during simulation within the development interface 118. The developer, in some implementations, may continue to modify, download and test additional versions of the application files 128 upon the target computing devices 130 in the manner described above. In some implementations, a developer may provision the target computing devices 130 with one or more test versions of the application files 128. Later, upon deciding that the test versions of the application files 128 are ready for deployment, the developer may prepare a computing device application for public distribution. For example, the developer may generate an installation executable for distribution or upload bundled presentation files to a network location as a web application. In some implementations, the test versions of the application files 128 may be provided to the target computing devices 130 via the development computing device 102 and/or the development server 106, while the application for public distribution may be provided for download by the web server 114 (e.g., via the application store 126).

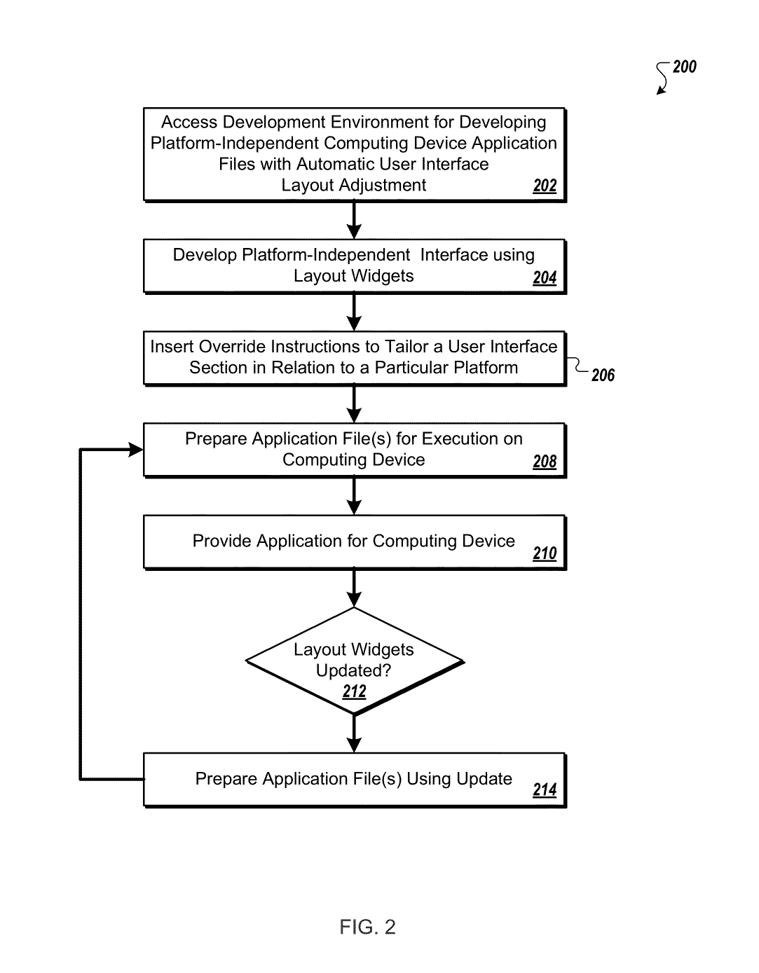

As shown in FIG. 2, a flow chart illustrates an example method 200 that may be used, in some implementations, for developing software applications for computing devices. In some implementations, the method 200 may be performed by the development client application 116 executing upon the development computing device 102, as described in relation to FIG. 1. In some implementations, the method 200 may be performed within a network environment for developing computing device applications, such as the network development environment 100 including the development server 106 and the development computing device 102, described in relation to FIG. 1.

In some implementations, the method 200 may begin with accessing an application development environment for developing computing device applications with automatic user interface layout adjustment (202). In some implementations, the application development environment may include features for designing, constructing, compiling, testing, and/or distributing software applications for a number of computing device platforms. The application development environment, in some implementations, may include one or more software tools, applications, algorithms, widgets, libraries, presentation files, media files, software development kits, and templates for generating application files for a software application designed for execution upon a computing device. The application development environment, in some implementations, may provide a developer with a development environment for generating application code for a computing device application that is removed from individual software development kits, integrated development environments and/or programming languages typically used for developing software applications for various platforms of computing devices. In some implementations, an application development environment for development of a computing device application with an automatically adapting user interface may involve an application developer interface installed on a local development computing device for developing and simulating the computing device application. The application developer interface, for example, may provide the developer with a communication channel to a network environment. In some implementations, the application development environment may be available via a network interface, such as an Internet browser interface. The application development interface, in some implementations, may provide an interface for developing a computing device application with an automatically adapting user interface that may be provisioned to one or more computing device platforms.

In some implementations, a platform-independent application user interface may be developed using layout widgets (204). The layout widgets, in some implementations, may provide platform-independent commands (e.g., calls, instructions, flags, tags, and/or hooks) that may later be linked to platform-specific user interface styles to automatically adapt the user interface to a particular computing device platform. In some implementations, development of a computing device application with an automatically adapting user interface may be enabled through an abstraction layer that allows the user interface of an application to be defined primarily through non-compiled resource files such as, in some examples, markup languages, interpreted languages, and style sheet languages. The non-compiled resource files, in some implementations, may be interpreted at run-time on the computing device to enable interactions between a user and the computing device. In some implementations, the non-compiled resource files may be interpreted by a browser engine feature of the computing device. In some implementations, the non-compiled resource files may be provided for presentation in a “windowless” (e.g., full screen, without defining browser border, etc.) web-browser interface rendered upon the computing device.

The non-compiled resource files, in some implementations, may include widgets that enable runtime configuration of computing device platform-specific styles such as, in some examples, font settings (e.g., style, size, opacity, color, etc.), background settings (e.g., color, image, borders, etc.), user interface element positions (e.g., navigation bar, header, footer, search field, etc.), white space definitions (e.g., margin, line spacing, etc.), and visual indicator appearance (e.g., icon sizings, icon opacity, icon styles, scroll bar styles, etc.). In some implementations, the non-compiled resource files may further include widgets (e.g., commands, links, flags, hooks, application programming interfaces, etc.) for interacting with device configuration settings or Web-based services such as device or platform-specific application programming interfaces (APIs). In a particular example, one or more non-compiled resource files may include commands for querying a computing device for platform-specific information. Using the platform-specific information, for example, the widgets may enable the automatic layout of user interface elements for style, sizing, and other visual presentation designed to be compatible with the platform-specific information.

In a specific example, in some implementations, a widget in the form of a tag in a markup language file may allow an application to link one or more layout designs, in the form style sheets, to the markup language file. In some implementations, a scripting language engine may insert information into the markup language file to link the platform-specific styles to the interface description. In some implementations, the layout of user interface element positions may be adjusted at runtime using the flexible box layout construct of the CSS scripting language. In this manner, for example, a navigation bar may be automatically positioned at the top of the screen for a first platform and at the bottom of the screen for a second platform without the need for specifying position at application development time. The appearance of visual indicators, in some implementations, may be adjusted at run time through the masking construct of the SVG graphic file format. In this manner, rather than downloading multiple images for multiple styles of visual indicators (e.g., scroll bars, cursors, icons, etc.), a single SVG file may be adjusted to alter its appearance.

In some implementations, override instructions may be inserted to tailor a user interface section to a particular platform (206). The widgets, in some implementations, may automatically adjust user interface elements according to platform-specific design constructs. If the developer is interested in modifying one or more of the design constructs, in some implementations, the developer may insert an override to one or more widgets, for example within one or more presentation files. The override, for example, may adjust position, sizing, opacity, color, font, or another graphical option (e.g., hide, suppress, modulate, etc.) of one or more elements within the user interface. In a particular example, the developer may adjust an icon style to a custom icon style rather than allowing the platform-specific styles to present a icon in the standard format of the device platform.

In some implementations, a developer may insert override instructions on a per-platform basis. For example, through an HTML flag, a developer may specify that, for platform Android™, the text of the title bar be left-formatted rather than centered. For all other platforms, for example, the text of the title bar may be adjusted per platform-specific layout style.

In some implementations, one or more application files may be prepared for deployment to a computing device (208). Once the developer has completed development of the computing device application with platform-independent interface, for example, the developer may prepare one or more presentation files for provision to a computing device. In some implementations, an installation file (e.g., executable file) may be generated including the application files configured for automatic user interface layout adjustment. For example, an executable file may be compiled for deployment to one or more device platforms. For example, a single executable file may be configured for deployment to any computing device including the Apple® Mac™ OS operating system, while the automatic interface adjustment may enable the automatic adaptation of the user interface to a number of Apple® iOS™ versions and/or device hardware configurations (e.g., iPhone™, iPad™, etc.). In some implementations, rather than a device executable, one or more presentation files may be bundled for provision within an executable already installed upon a computing device. For example, the application file(s) plus, optionally, other files, may be combined into a downloadable file for use with an application installed upon a computing device. In some implementations, the downloadable file(s) may be provided at a network location for consumption as a web application by a browser application executing upon a computing device.

In some implementations, the application file(s) may be provided to a computing device (210). In some implementations, the application file(s) may be provided at a network address, and a computing device may download the application file(s) from the network address. The application file(s), in some implementations, may be pushed to a computing device. For example, the application file(s) may be pushed to a computing device over a wired or wireless connection with a development computing device. In some implementations, the computing device may install the application file(s) through an application store interface executing upon the computing device.

In some implementations, an update of the layout widgets may be received (212). In some implementations, one or more widgets may be updated and/or added to modify existing user interface layouts and styles. For example, the layout widgets may be updated in relation to deployment of a new platform such as, in some examples, a new operating system version, a new device configuration, a new device application format or a new device application format version. In some implementations, a developer may upgrade an existing computing device application to allow it to be compatible with the new platform.

In some implementations, one or more updated application files may be prepared using the layout widget update (214). In some implementations, a developer may test the computing device application with the new platform. For example, one or more development files may be combined with the layout widget update to create an application version compatible with a new platform. The developer, in some implementations, may adjust one or more development files, for example to use a new widget or a modified version of a widget (e.g., taking in a modified set of inputs, etc.).

In some implementations, one or more updated application files may be prepared for deployment to a computing device (208). For example, as discussed above, an executable file may be compiled, a downloadable file may be bundled and deployed, or updated files may be provided at a network location for consumption by a browser. In the example of a web application executing within a browser application, for example, a refresh of the browser may allow receipt of the updated application files. In this manner, as new platforms become available and/or bug fixes are made, a developer may maintain a computing device application that is capable of deployment over a wide range of device platforms.

Although described in a particular series of steps, in some implementations, more or fewer steps may be included in the method 200. For example, a developer may not opt to insert override instructions (206). In some implementations, one or more of the steps of the method 200 may be performed in a different order. For example, overrides may be inserted (206) at any point during development (204) and may or may not be identified as separate distinct steps of a process. Other modifications are possible while maintaining the spirit and scope of the method 200.

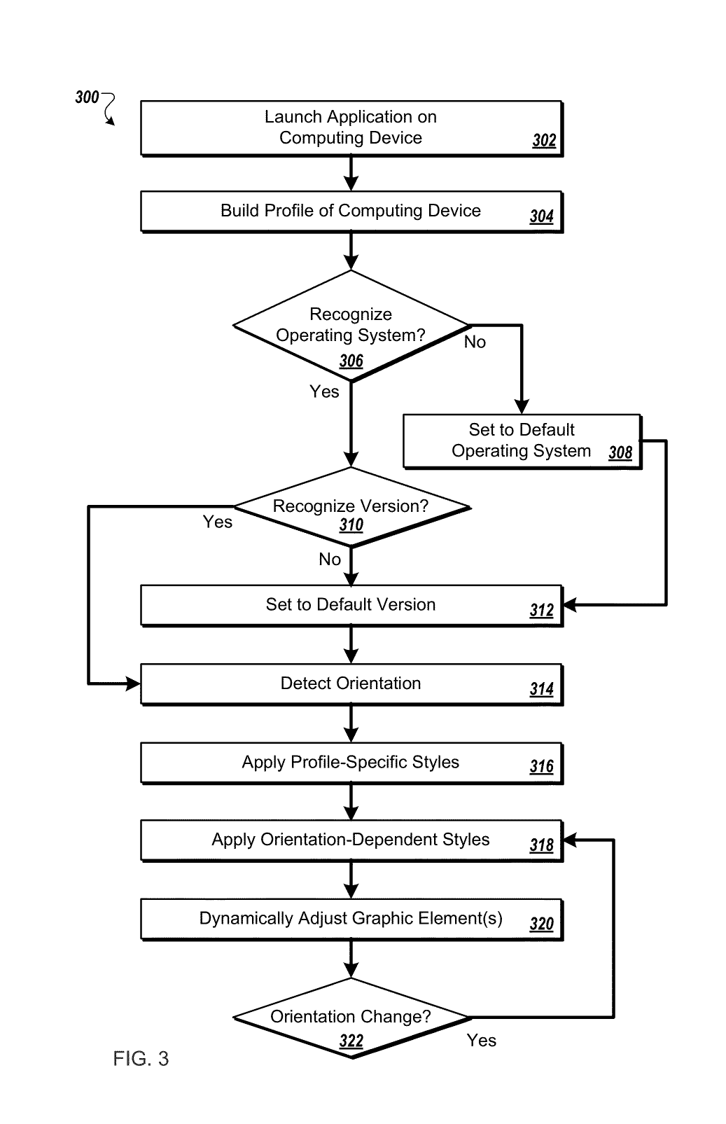

FIG. 3 is a flow chart illustrating an example method 300 that may be used, in some implementations, for executing a software application with automatically adjusting user interface upon a computing device. The method 300, in some implementations, may be performed on one or more of the target computing devices 130 as described in relation to FIG. 1.

In some implementations, the method 300 may begin with launching an application having an automatically-adaptable user interface on a computing device (302). The application, for example, may have been developed in an application development environment such as the network development environment 100 described in relation to FIG. 1. Launching the application, for example, may include installing the application, beginning execution of the application upon the computing device, downloading application files into a browser application as a web application, and/or opening a user interface of the application in a display area of the computing device.

In some implementations, a profile of the computing device may be built (304). The profile, for example, may include platform information such as, in some examples, a particular set of configuration parameters such as one or more of a device operating system, a device version, a device application format, a device orientation, and a device peripheral configuration. In some implementations, the application may call into one or more application programming interfaces of the computing device to collect information regarding the platform information. The profile, in some implementations, may include information previously registered by a user of the computing device. For example, registration information collected on the computing device or stored at a network location accessible to the computing device may supply a portion of the profile information to the application. In some implementations, the application may access a previously-stored profile, for example containing information collected during prior execution of the application upon the computing device. In some implementations, the application may query a user regarding a portion of the profile information. For example, the application may pose one or more graphical and/or audible questions to a user regarding the configuration of the computing device.

In some implementations, if the operating system of the computing device is not recognized (306) a default operating system may be set (308). In some implementations, the application may query the computing device regarding an operating system. In the circumstance of a browser-based application, in some implementations, the application may use a browser construct for determining the platform of the computing device. In some implementations, in the circumstance of application files including JavaScript™ files, a JavaScript™ construct for operating system determination may be used. The application, in some implementations, may access a preset memory location (e.g., operating system file, etc.) in the computing device for information regarding the operating system. If the application is unable to determine the operating system installed upon the computing device, in some implementations, the application may be configured to default to a particular operating system. In some implementations, rather than defaulting to a single operating system, the application may query a user to select from two or more default operating systems.

In some implementations, if an operating system version is not recognized (310), or if a default operating system was set (308), a default operating system version may be set (312). For example, if the operating system version is newer than known operating system versions at the time of development of the application, the application may default to a previous (e.g., known) version of the operating system. In some implementations, rather than defaulting to a version of the operating system, the application may query a user to select from two or more default operating system versions.

In some implementations, a device orientation may be detected (314). For example, the application may use an application programming interface of the computing device to determine an orientation of the computing device. In some implementations, the application may not be able to determine the device orientation, for example if the operating system was not recognized (306).

In some implementations, profile-specific styles may be applied to a user interface of the application (316). The profile-specific styles, in some examples, may include font settings (e.g., style, size, opacity, color, etc.), background settings (e.g., color, image, borders, etc.), user interface element positions (e.g., navigation bar, header, footer, search field, etc.), whitespace definitions (e.g., margin, line spacing, etc.), and visual indicator appearance (e.g., icon sizings, icon opacity, icon styles, scroll bar styles, etc.). In some implementations, applying profile-specific styles may include linking one or more platform-specific presentation files to a platform-independent presentation file. For example, a platform-specific style library may be linked to a platform-independent non-compiled (e.g., runtime-interpretable) resource file. A non-compiled resource file may include, in some examples, markup languages such as HyperText Markup Language (HTML), interpreted languages such as JavaScript™, and style sheet languages such as Cascading Style Sheets (CSS). In some implementations, a platform-specific non-compiled resource file (e.g., interpreted language file) may be linked to a platform-independent non-compiled resource file (e.g., style sheet) to apply profile-specific styles to the application interface. In a particular example, one or more CSS files may be linked to an HTML file by a JavaScript™ algorithm to prepare the application, or a view of the application, for rendering as a user interface with platform-specific design layout. The CSS, for example, may specify positioning layout styles, background styles, and font styles.

In some implementations, applying profile-specific styles may include correlating a platform-independent function call to a platform-specific algorithm. For example, a platform-independent function call may be linked to an API of the computing device.

the device orientation is known, in some implementations, orientation-dependent profile-specific styles may be applied to a user interface of the application (318). In some implementations, platform-specific styles may include orientation-independent styles and orientation dependent styles. For example, a font style, icon style, or background color may be independent of orientation, while positioning information may be dependent of orientation. In some implementations, the application may include only orientation-independent styles or, conversely, only orientation-dependent styles. In some implementations, orientation modifications may be provided for within a single layout template (e.g., a single CSS file or set of CSS files). For example, in some implementations, a developer need not be aware that the layout framework conducts orientation adjustments such as, in some examples, positioning, spacing, and/or margin adjustments, to translate between a vertical orientation and a horizontal orientation.

In some implementations, one or more graphical elements may be dynamically adjusted prior to rendering upon a display of the computing device based upon one or more profile-specific styles (320). During execution of the application, one or more runtime-interpretable files may include instructions for presenting a user interface. Through the platform-specific styles, one or more graphical elements may be adjusted in one or more of position, size, color, and opacity prior to rendering to the display. For example, through calls to linked library functions, style sheets, or other style-determining resource files, the graphical elements described by a sequence of instructions of a platform-independent presentation file may be automatically adjusted to provide a platform-specific user interface display. In a particular example, the appearance of one or more visual indicators may be adjusted prior to rendering through the masking construct of the SVG graphic file format. Style sheet instructions, for example, may include instructions for applying a masking construct to an SVG file based on a platform-specific icon style.

If an orientation change is detected (322), in some implementations, one or more orientation-dependent styles may be applied (318). For example, library links, style sheets, API calls, and/or other connections between a platform-independent presentation file and one or more platform-specific styles may be automatically adjusted to include style adjustments specific to a second orientation. In some implementations, a present display may be refreshed to adjust to the current computing device orientation.

Although described in a particular series of steps, in some implementations, more or fewer steps may be included in the method 300. For example, if either the operating system is not recognized (306) or the operating system version is not recognized (310), in some implementations, the application may query one or more application programming interfaces or access one or more preset file locations to collect information that may be used to intuit an operating system or operating system version. For example, based upon a display configuration, peripheral capabilities, or device identifier (e.g., including a code referencing a particular manufacturer, hardware configuration, or hardware platform), the application may default to a particular operating system and/or operating system version.

In some implementations, one or more of the steps of the method 300 may be performed in a different order. For example, in some implementations, one or more profile-specific styles may be applied (316) prior to detecting an orientation of the computing device (314). For example, in some implementations, the non-compiled resource files may include commands for interacting with device configuration settings or Web-based services such as device or platform-specific application programming interfaces (APIs). An example command for interacting with device configuration settings may be an API for determining orientation of the device. Upon determining the computing device profile (304), including the operating system and, optionally, the operating system version, for example, a profile-specific style may be applied (316) allowing the application to interact with an orientation API.

Other modifications are possible while maintaining the spirit and scope of the method 300. For example, in some implementations, in addition to platform information, the profile of the computing device may include additional factors used in selecting specific styles. In one example, accessibility options may be used to select platform-specific, accessibility-oriented styles to apply (316). For example, a user interface for the vision-impaired on a first platform may vary in display options from a user interface for the vision-impaired on a second platform.

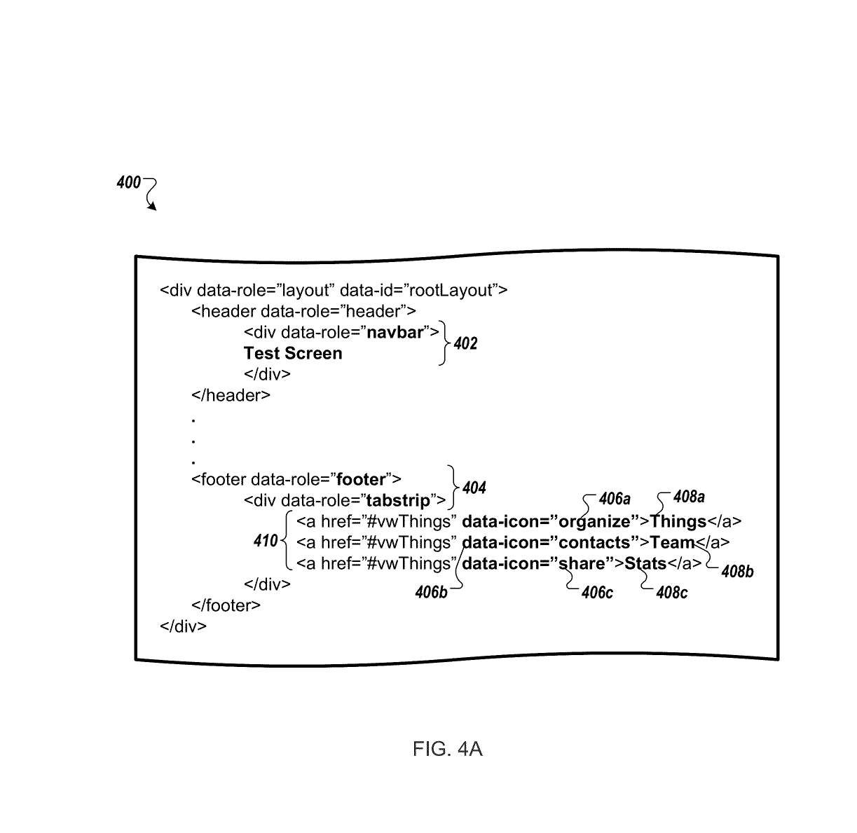

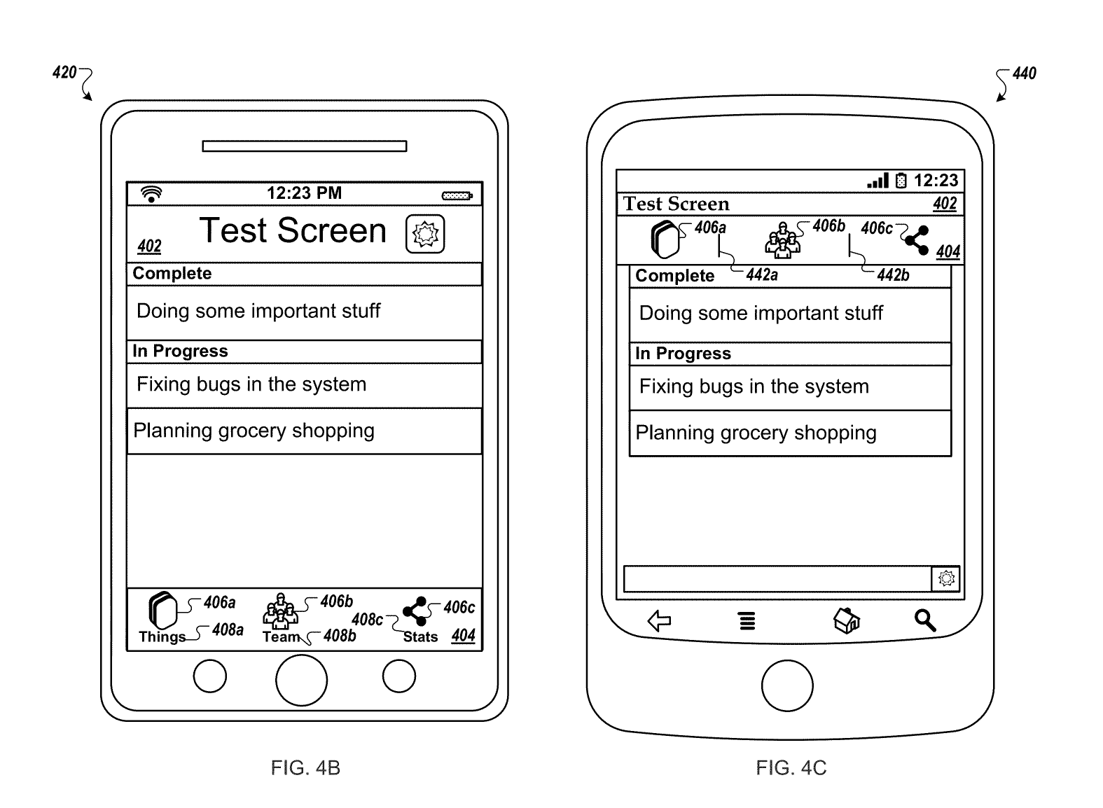

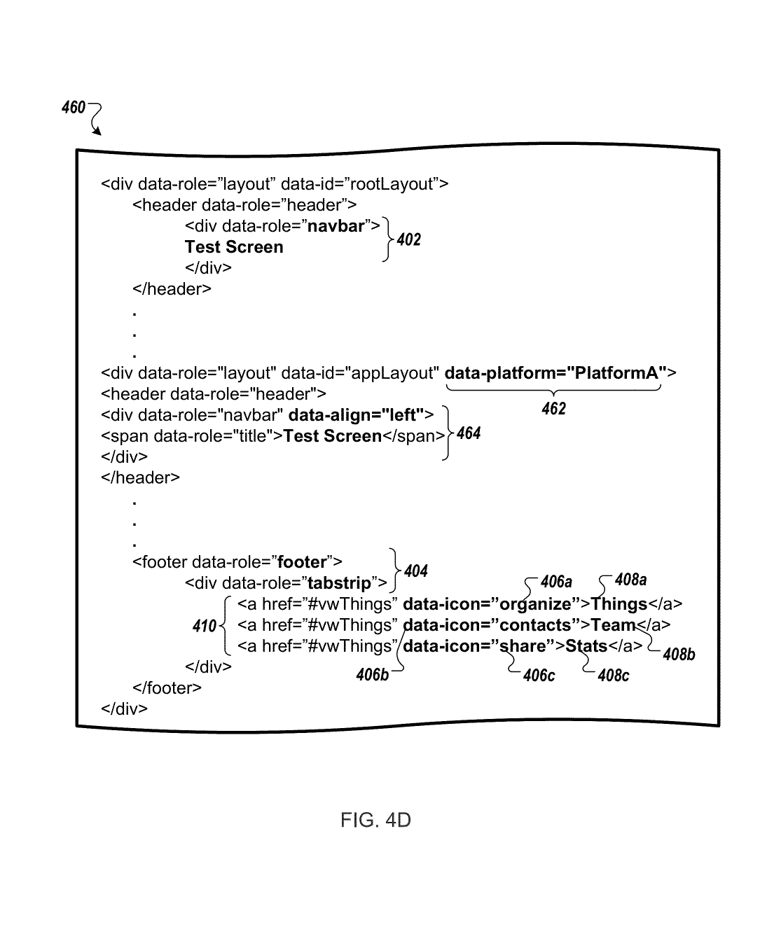

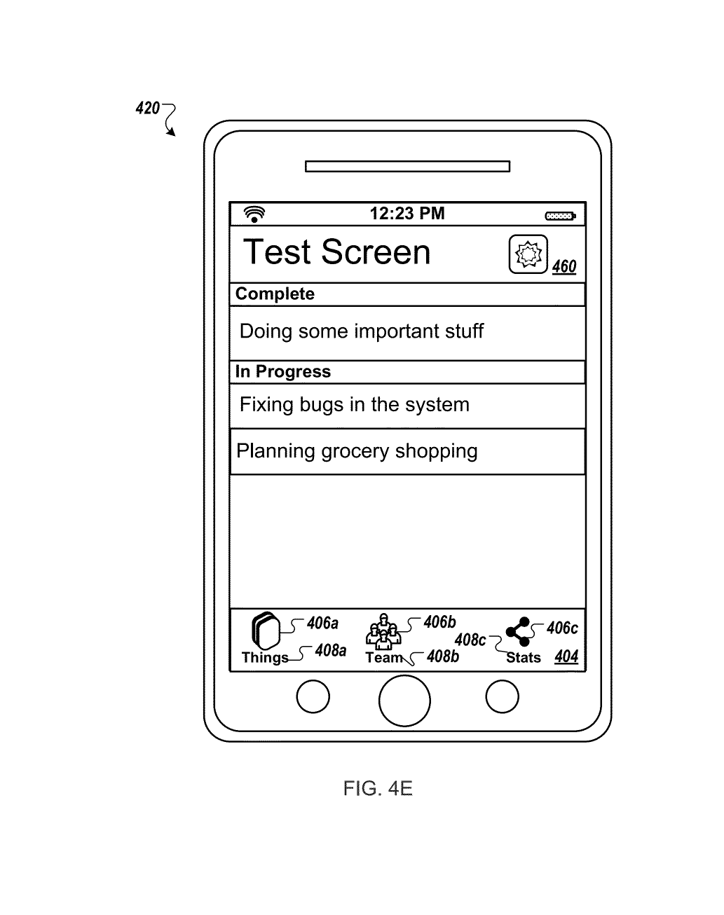

FIGS. 4A through 4E illustrate example pseudocode and corresponding example user interfaces rendered upon example computing devices. The pseudocode, for example, may reflect a combination of platform-specific and platform-independent instructions for developing an application user interface for a computing device, while the example user interfaces may display an example rendering of the pseudocode within a display area of an example computing device.

Beginning with FIG. 4A, an example pseudocode snippet 400 may illustrate markup language including platform-independent statements. The platform-independent statements may be included during development of a computing device application, in some implementations, to denote portions of the markup language that may be processed at run time to apply platform-specific user interface settings. In some implementations, a platform-independent statement may include a markup language tag, such as an HTML tag. In some implementations, a platform-independent statement such as a platform-independent statement 402 may include the tag “data-role” to define a role (e.g., section of the computing device display) for presentation of the information contained within the platform-independent statement. According to the platform-independent statement 402, for example, tag “data-role” is associated with a display section “navbar” (e.g., navigational bar). As illustrated within the platform-independent statement 402, for example, the “navbar” display section may contain the text “Test Screen.”

Other information, in some implementations, may be included within a display section noted by a “data-role” tag such as, in some examples, one or more images, videos, and user-selectable screen elements. For example, as illustrated by a second platform-independent statement 404, associated with a display section “footer” and display sub-section “tabstrip”, a series of three statements 410 describe a series of data icons 406 (e.g., images) associated with hypertext references (e.g., selectable screen elements) for display within the display sub-section “tabstrip”, along with associated text 408.

At runtime, in some implementations, the sections denoted by the platform-independent statements 402 and 404 may be modified and/or interpreted according to platform-specific interface styles. Turning to FIG. 4B, in some implementations, the platform-independent statements 402 and 404 may be rendered upon a first computing device platform 420 as illustrated. For example, the first platform-independent statement 402 may be rendered within a top portion of the first computing device platform 420, with the text “Test Screen” centered within a section (e.g., “navbar” section) and displayed in a particular font. In some examples, one or more of layout (e.g., top of screen), positioning (e.g., within the “navbar” section), font settings, background settings (e.g., color, image, etc.), and control properties (e.g., selectable, etc.) may be adjusted or applied at runtime based upon platform-specific settings.

Similarly, as illustrated in a bottom section of the display of the first computing device platform 420, the second platform-independent statement 404 may be rendered to display each data icon 406 centered above the respective associated text 408. In some implementations, the size and opacity of each data icon 406 may have been adjusted by platform-specific styles prior to rendering to the display. Additionally, as noted above in relation to the first platform-independent statement 402, one or more of layout (e.g., top of screen), positioning (e.g., within the “navbar” section), font settings, background settings (e.g., color, image, etc.), and control properties (e.g., selectable, etc.) of the data icons 406 and/or the associated text 408 may have been adjusted or applied at runtime based upon platform-specific settings.

In comparison, turning to FIG. 4C, in some implementations, the presentation of the platform-independent statements 402 and 404 may differ dramatically when platform-specific styles are applied prior to rendering to a second computing device platform 440. For example, although the first platform-independent statement 402 is similarly rendered within a top portion of the display, the relative dimensions of the top portion is substantially narrower on the second computing device platform 440 than on the first computing device platform 420. Additionally, the text “Test Screen”, as rendered to the display of the second computing device platform 420, is left-justified rather than centered, the font size is smaller, and the font style is different.

Beneath the rendering of the first platform-independent statement 402, within the display of the second computing device platform 440, the second platform-independent statement 404 is rendered. Layout style of the second computing device platform 440, as judged by the positioning of the display elements, for example, may render a “tabstrip” section towards the top of the screen (e.g., beneath the “navbar” section), rather than on the bottom of the display as illustrated by the first computing device platform 420. Separating bars 442, in the example of the second computing device platform 440, are rendered between each pair of data icons 406. The associated text 408, in the example of the second computing device platform 440, is not displayed at all.

The differences in the rendering of the information contained within the first platform-independent statement 402 and the second platform-independent statement 404, as rendered to the first computing device platform 420 in comparison to the second computing device platform 440, may depend primarily from the differences in the platform-specific layout styles automatically applied prior to rendering to the display. However, in some implementations, a developer may choose to apply one or more override statements, for example to customize the appearance of one or both of the platform-independent statements 402 and 404 upon a particular computing device platform. For example, turning to FIG. 4D, an example pseudocode snippet 460 may illustrate the markup language of the pseudocode snippet 400 (e.g., as shown in FIG. 4A) with the addition of a platform-dependent override statement 462 including platform-dependent presentation overrides 464. For example, the platform-dependent override statement 462 specifies that the override be applied to “Platform A”. In some implementations, “Platform A” may refer to the platform illustrated as the first computing device platform in FIG. 3B. The platform-dependent presentation overrides 464, for example, may specify a particular rendering of the “Test Screen” text upon any device having the computing device platform of “Platform A”. The platform-dependent presentation overrides 464, for example, specify “data-align=‘left’”. As illustrated in FIG. 4B, for example, the text “Test Screen” is illustrated as being centered within the top portion of the screen. Turning to FIG. 4E, the first computing device platform 420, in some implementations, may render the pseudocode snippet 460 by presenting the text “Test Screen” in a left-justified position. In some implementations, platform-specific styles not specifically overridden within the platform-dependent presentation overrides 464 may remain in place. For example, platform-specific settings pertaining to one or more of layout (e.g., top of screen), positioning (e.g., vertically), font settings, background settings (e.g., color, image, etc.), and control properties (e.g., selectable, etc.) of the “navbar” section including the text “Test Screen” may still be reflected in the presentation as illustrated in the first computing device platform 420 as shown in FIG. 4E. In some implementations, styles not specifically overridden within the platform-dependent presentation overrides 464 may be rendered as default styles such as, in some examples, browser default font type, font size, and background color settings.

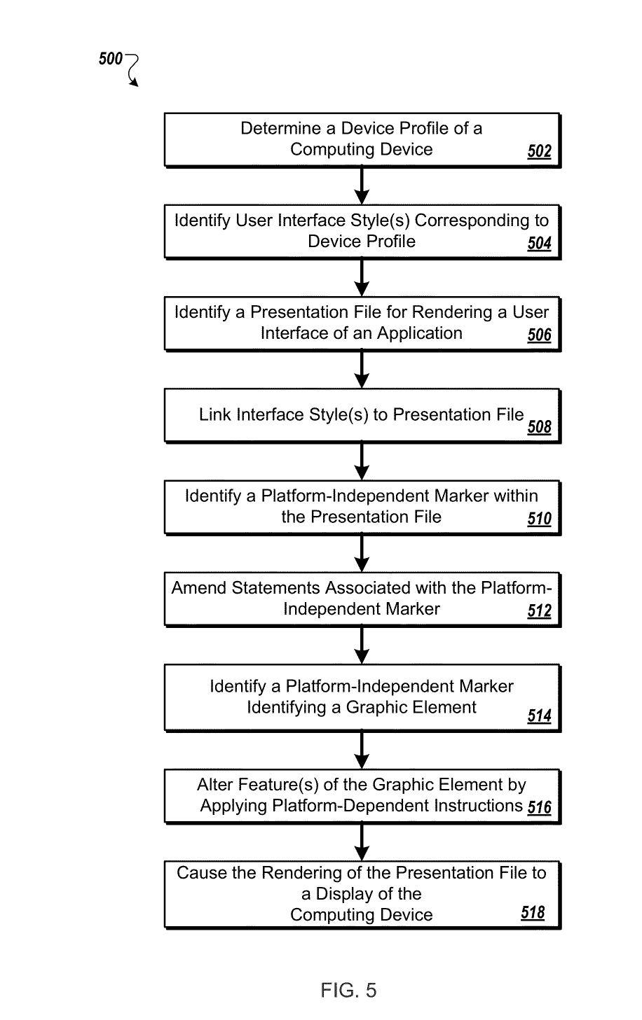

FIG. 5 is a flow chart illustrating an example method 500 that may be used, in some implementations, for applying platform-specific styles to a platform-independent presentation file prior to rendering to a display. The method 500, in some implementations, may be performed on one or more of the target computing devices 130 as described in relation to FIG. 1.

In some implementations, the method 500 may begin with determining a device profile of a computing device (502). The device profile, in some implementations, may be determined as described in relation to steps 304 through 312 of the method 300 of FIG. 3. The device profile, for example, may include platform information such as, in some examples, a particular set of configuration parameters such as one or more of a device operating system, a device application format, and a device peripheral configuration. In some implementations, the application may call into one or more application programming interfaces of the computing device to collect information regarding the platform information. The device profile, in some implementations, may include information previously registered by a user of the computing device. For example, registration information collected on the computing device or stored at a network location accessible to the computing device may supply a portion of the profile information to the application. In some implementations, the application may access a previously-stored profile, for example containing information collected during prior execution of the application upon the computing device. In some implementations, the application may query a user regarding a portion of the profile information. For example, the application may pose one or more graphical and/or audible questions to a user regarding the configuration of the computing device.

In some implementations, user interface styles corresponding to the device profile may be identified (504). For example, one or more files such as, in some examples, style sheets, scripting language files, libraries, and/or markup language files may be identified as containing information specifying one or more style layouts specific to an identified platform.

In some implementations, a presentation file for rendering a user interface of a computing device application may be identified (506). The presentation file, in some implementations, may be a markup language file, such as an HTML file.

In some implementations, the interface styles may be linked to the presentation file (508). In some implementations, one or more interface style libraries may be linked to the presentation file. In some implementations, a script may be executed to alter the presentation file to add links to one or more interface style libraries. For example, a scripting language algorithm may be executed to modify a markup language file to add statements identifying one or more style sheet files.

In some implementations, a platform-independent marker may be identified within the presentation file (510). The platform-independent marker may include, for example, a code flag, particular character string or text statement within a comment portion of the presentation file, HTML tag, or other character or set of characters identifying platform-independent statements that may qualify for alteration, modification, or replacement using platform-specific layout style information. In a particular example, the platform-independent marker may include an HTML tag identifying a display section (e.g., header, footer, navigation bar, etc.) such as the HTML tag “data-role=‘navbar’” illustrated within the platform dependent statement 402 of the pseudocode 400, as illustrated in FIG. 4A.

In some implementations, statements associated with the platform-independent tag may be amended (512). In some implementations, a script may be executed to alter the presentation file to add or modify one or more markup language statements to reflect platform-specific styles. For example, a JavaScript™ program may be executed to include platform-specific presentation statements affecting, in some examples, font settings, background settings, and/or user interface element positions.

In some implementations, a platform-independent marker identifying a graphic element may be identified (514). The platform-independent marker may include, for example, a code flag, particular character string or text statement within a comment portion of the presentation file, an HTML tag, or other character or set of characters identifying platform-independent statements that may qualify for alteration, modification, or replacement using platform-specific layout style information. The platform-independent marker identifying a graphical element, in some implementations, may be identifiable in part by relative placement within a section identified by a section-specific platform-independent marker. In a particular example, the section-specific platform-independent marker may include an HTML tag identifying a display section (e.g., header, footer, navigation bar, etc.) such as the HTML tag “data-role=‘tabstrip’” illustrated within the platform dependent statement 404 of the pseudocode 400, as illustrated in FIG. 4A. Further to the example, the HTML tag “data icon” (e.g., as illustrated by the data icons 406), related to the “tabstrip”, may be identified, in some implementations, as a platform-independent graphic element.

In some implementations, one or more features of the graphic element may be altered by applying platform-specific instructions (516). In some implementations, a script may be executed to alter a particular graphic file to apply platform-specific settings. The platform-specific settings, in some examples, may adjust one or more of size, shape, color, and opacity of the graphic element. For example, a script may be executed to apply resolution independent vector masks or high resolution bitmaps with an Alpha channel to a graphic file. In a particular example, a JavaScript™ algorithm may be executed to apply one or more vector-based, resolution independent masks to an SVG graphic file according to an identified platform-specific style.

In some implementations, the presentation file may be rendered to a display of the computing device (518). The presentation file, in some implementations, may be rendered to the display of the computing device by an application capable of interpreting and rendering content files at runtime. For example, a browser engine may interpret markup language files, style sheet files, and scripting language files for execution. In some implementations, the presentation file may be interpreted by a browser engine feature of the computing device. In some implementations, the presentation file may be provided for presentation in a “windowless” (e.g., full screen, without defining browser border, etc.) web-browser interface rendered upon the computing device.

Other modifications are possible while maintaining the spirit and scope of the method 500. For example, in some implementations, rather than modifying the presentation file to link one or more interface styles to the presentation file (508), the method 500 may include relocating and/or renaming a library file to position that particular platform-specific library file for inclusion by the presentation file. In another example, in some implementations, rather than altering features of a graphic element (516), a platform-specific graphic element may replace a default graphic element. For example, based upon platform, a script may be executed to replace a file linked to the presentation file (e.g., moving a new graphic file to a location pointed to by a hyperlink reference) or to rewrite a portion of the presentation file referring to a graphic file (e.g., rewrite a hyperlink reference to point to a different graphic file).

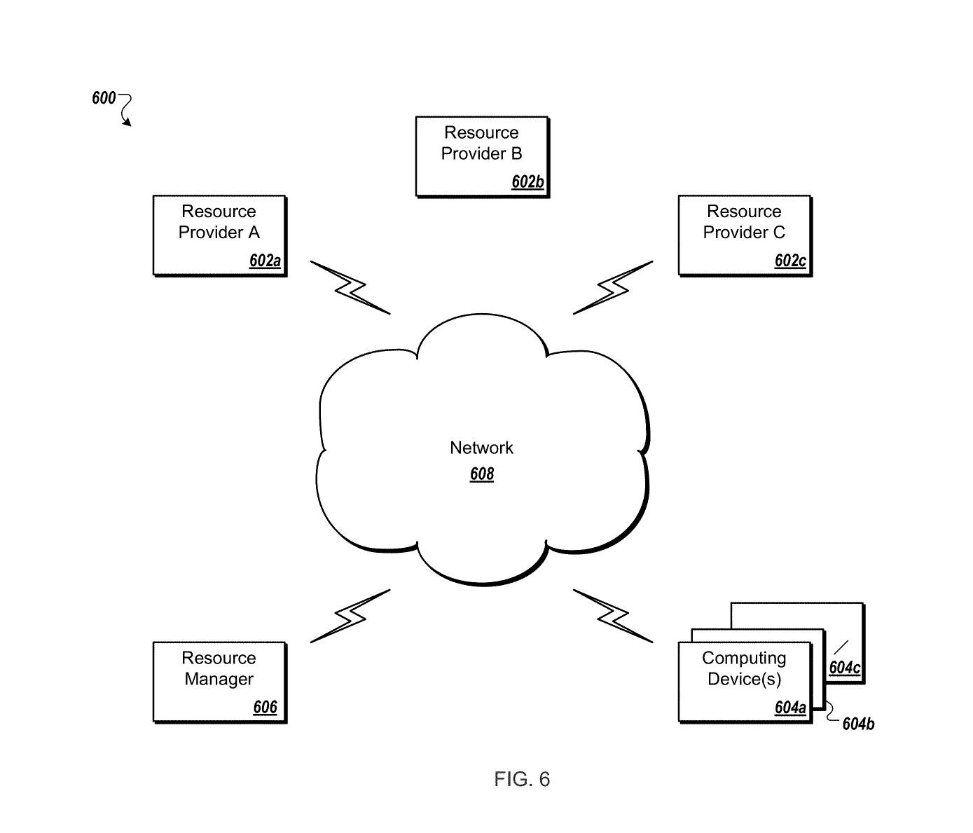

As shown in FIG. 6, an implementation of an exemplary cloud computing environment 600 for development of software applications with an automatically adapting user interface is shown and described. The cloud computing environment 600 may include one or more resource providers 602a, 602b, 602c (collectively, 602). Each resource provider 602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 602 may be connected to any other resource provider 602 in the cloud computing environment 600. In some implementations, the resource providers 602 may be connected over a computer network 608. Each resource provider 602 may be connected to one or more computing device 604a, 604b, 604c (collectively, 604), over the computer network 608.

The cloud computing environment 600 may include a resource manager 606. The resource manager 606 may be connected to the resource providers 602 and the computing devices 604 over the computer network 608. In some implementations, the resource manager 606 may facilitate the provision of computing resources by one or more resource providers 602 to one or more computing devices 604. The resource manager 606 may receive a request for a computing resource from a particular computing device 604. The resource manager 606 may identify one or more resource providers 602 capable of providing the computing resource requested by the computing device 604. The resource manager 606 may select a resource provider 602 to provide the computing resource. The resource manager 606 may facilitate a connection between the resource provider 602 and a particular computing device 604. In some implementations, the resource manager 606 may establish a connection between a particular resource provider 602 and a particular computing device 604. In some implementations, the resource manager 606 may redirect a particular computing device 604 to a particular resource provider 602 with the requested computing resource.

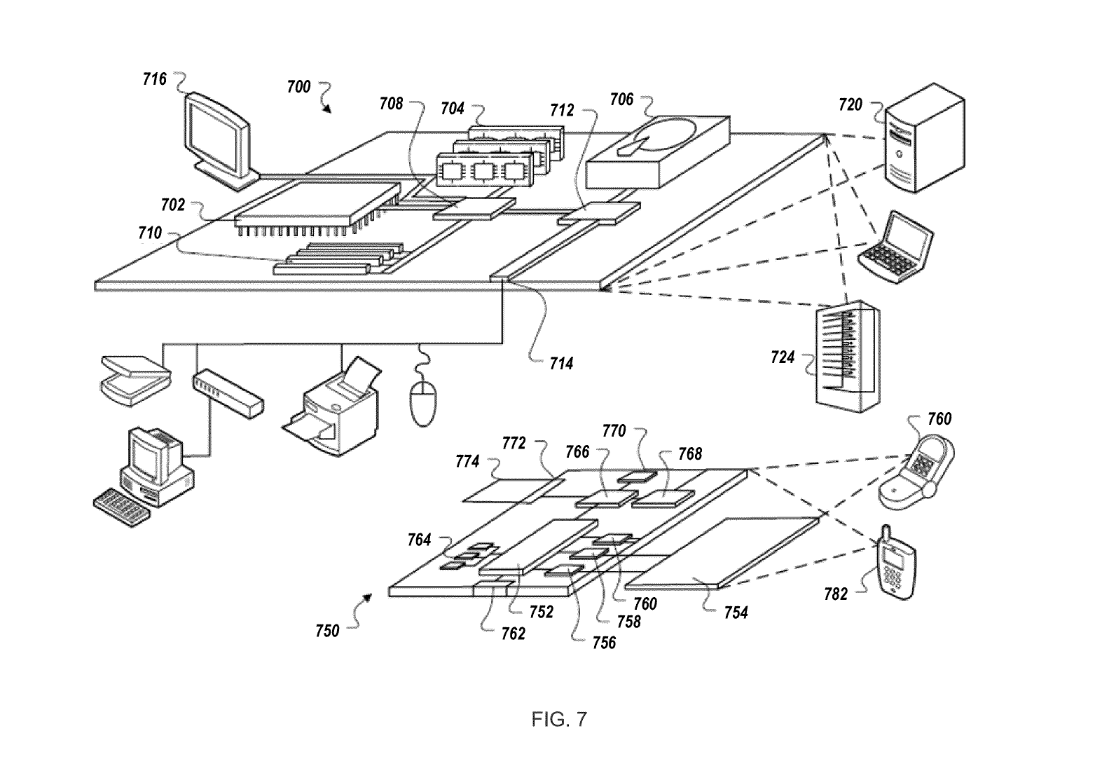

FIG. 7 shows an example of a computing device 700 and a mobile computing device 750 that can be used to implement the techniques described in this disclosure. The computing device 700 is intended to represent various forms of digital computers, such as laptops, desktops, workstations, smart televisions, servers, blade servers, mainframes, and other appropriate computers. The mobile computing device 750 is intended to represent various forms of mobile devices, such as personal digital assistants, cellular telephones, smart-phones, tablet computers, portable gaming devices, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth®, Wi-Fi™, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, environments and methods for developing and distributing software applications with an automatically adapting user interface are provided. Having described certain implementations of methods and apparatus for supporting the development and distribution of software applications with an automatically adapting user interface, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method comprising:
determining, by a processor of a computing device, a device profile of the computing device;
accessing, by the processor, a plurality of user interface styles, wherein each user interface style of the plurality of user interface styles corresponds to a respective device profile of a plurality of device profiles, and wherein the plurality of device profiles comprises the device profile;
identifying, by the processor, a first user interface style of the plurality of user interface styles, wherein the first user interface style is identified based in part upon at least a portion of the device profile of the computing device;
applying, by the processor, the first user interface style to a first presentation file of one or more presentation files to determine a first platform-specific presentation file, wherein:
an application installed upon the computing device comprises the one or more presentation files, and
the one or more presentation files define a portion of a graphical user interface;
interpreting, by the processor, at least a portion of the first platform-specific presentation file;
based upon interpretation of at least the portion of the first platform-specific presentation file, altering one or more features of a graphical element of the graphical user interface, wherein
the one or more features of the graphical element are altered based in part upon the first interface style; and
rendering, to a display, the graphical user interface.

2. The method of claim 1, wherein the one or more features of the graphical element comprise at least one of size, color, and position.

3. The method of claim 1, wherein applying the first user interface style to the first presentation file comprises including a library in the first presentation file.

4. The method of claim 1, further comprising:
detecting, by the processor, an orientation of the computing device; wherein
the first user interface style is identified further based in part upon the orientation of the computing device.

5. The method of claim 4, further comprising:
determining, by the processor, a change in the orientation of the computing device;
identifying by the processor, a second user interface style of the plurality of user interface styles, wherein
the second user interface style is identified based in part upon
(a) at least a portion of the device profile of the computing device, and
(b) the change in the orientation;
applying, by the processor, the second user interface style to the first presentation file to determine a second platform-specific presentation file; and
interpreting, by the processor, the second platform-specific presentation file to render the graphical user interface of the application to the display.

6. The method of claim 1, wherein the device profile comprises an operating system.

7. The method of claim 1, wherein the first presentation file comprises a markup language file.

8. The method of claim 7, wherein the markup language file comprises one or more platform-independent statements.

9. The method of claim 8, wherein applying the first user interface style to the first presentation file comprises amending one or more statements of the markup language file, wherein the one or more statements are identified, in part, by the one or more platform-independent statements.

10. The method of claim 1, wherein the first user interface style comprises a style sheet file.

11. The method of claim 1, wherein:
the graphical element comprises an image file; and
altering the one or more features of the graphical element comprises executing runtime-interpretable instructions to alter rendering of the image file.

12. The method of claim 1, wherein determining the device profile comprises executing runtime-interpretable instructions, wherein an interpretation language file comprises the runtime-interpretable instructions.

13. The method of claim 12, wherein the application comprises the interpretation language file.

14. The method of claim 1, wherein the application comprises the plurality of user interface styles.

15. A method comprising:
determining, by a processor of a computing device, a device platform of the computing device;
applying, by the processor, a first interface style to a presentation file to determine a platform-specific presentation file, wherein:
an application installed upon the computing device comprises the presentation file,
the presentation file comprises a plurality of runtime-interpretable statements, wherein the plurality of runtime-interpretable statements comprise one or more platform-independent statements and one or more override statements, and
applying the first interface style to the presentation file comprises:
identifying a first platform-independent statement of the one or more platform-independent statements,
responsive to identifying the first platform-independent statement, applying a platform-specific style feature to a first graphical element,
identifying a first override statement of the one or more override statements, wherein the first override statement comprises at least a first override platform, and
responsive to identifying the first override platform as the device platform of the computing device, maintaining one or more override style features, wherein the one or more override style features are associated with a second graphical element;
interpreting, by the processor, at least a portion of the platform-specific presentation file, wherein the platform-specific presentation file defines a portion of a graphical user interface; and
rendering, to a display, the graphical user interface.

16. The method of claim 15, wherein the platform-specific style feature and the one or more override style features each comprise one or more of a size, position, and color.

17. A method comprising:
determining, by a processor of a computing device, a platform of the computing device;
based at least in part upon the platform, altering, by the processor, a platform-independent presentation file; and
determining, by the processor, a platform-specific graphical user interface of a software application based at least in part on the platform-independent presentation file.

18. The method of claim 17, wherein altering the platform-independent presentation file further comprises:
applying, by the processor, a platform-specific user interface style to the platform-independent presentation file.

19. The method of claim 18, wherein the platform-independent presentation file comprises a statement that identifies a graphical element of the graphical user interface; and wherein the platform-specific user interface style comprises a property to apply to the graphical element.

20. The method of claim 18, wherein the platform-independent presentation file further comprises an override statement.

21. The method of claim 20, further comprising:
maintaining, without modification, a second property to apply to a second graphical element based at least in part on the override statement.

22. The method of claim 17, further comprising:
determining an orientation of the computing device.

23. The method of claim 22, wherein altering the platform-independent presentation file further comprises:
altering the platform-independent presentation based at least in part on the orientation.

24. The method of claim 17, further comprising:
rendering, by the processor, the platform-specific graphical user interface to a display.

25. The method of claim 17, wherein the property comprises at least one of:
a position;
a layout;
a control property;
a size;
a font setting; and
a background setting.

26. A system comprising:
a processor; and
a memory storing instruction thereon, wherein the instructions when executed cause the processor to:
determine a device profile of a computing device;
access a plurality of user interface styles, wherein each user interface style of the plurality of user interface styles corresponds to a respective device profile of a plurality of device profiles, and wherein the plurality of device profiles comprises the device profile;
identify a first user interface style of the plurality of user interface styles, wherein the first user interface style is identified based in part upon at least a portion of the device profile of the computing device;
apply the first user interface style to a first presentation file of one or more presentation files to determine a first platform-specific presentation file, wherein:
an application installed upon the computing device comprises the one or more presentation files, and
the one or more presentation files define a portion of a graphical user interface;
interpret at least a portion of the first platform-specific presentation file;
based upon interpretation of at least the portion of the first platform-specific presentation file, alter one or more features of a graphical element of the graphical user interface, wherein
the one or more features of the graphical element are altered based in part upon the first interface style; and
render, to a display, the graphical user interface.

27. The system of claim 26, wherein the computing device comprises the processor.

28. A non-transitory computer readable medium having instructions stored thereon that, when executed, cause a processor to:
determine a device profile of a computing device;
access a plurality of user interface styles, wherein each user interface style of the plurality of user interface styles corresponds to a respective device profile of a plurality of device profiles, and wherein the plurality of device profiles comprises the device profile;
identify a first user interface style of the plurality of user interface styles, wherein the first user interface style is identified based in part upon at least a portion of the device profile of the computing device;
apply the first user interface style to a first presentation file of one or more presentation files to determine a first platform-specific presentation file, wherein:
an application installed upon the computing device comprises the one or more presentation files, and
the one or more presentation files define a portion of a graphical user interface;
interpret at least a portion of the first platform-specific presentation file;
based upon interpretation of at least the portion of the first platform-specific presentation file, alter one or more features of a graphical element of the graphical user interface, wherein
the one or more features of the graphical element are altered based in part upon the first interface style; and
render, to a display, the graphical user interface.

29. The computer readable medium of claim 28, wherein the computing device comprises the processor.

30. A system comprising:
a processor; and
a memory storing instruction thereon, wherein the instructions when executed cause the processor to:
determine a device platform of a computing device;
apply a first interface style to a presentation file to determine a platform-specific presentation file, wherein:
an application installed upon the computing device comprises the presentation file,
the presentation file comprises a plurality of runtime-interpretable statements, wherein the plurality of runtime-interpretable statements comprise one or more platform-independent statements and one or more override statements, and
applying the first interface style to the presentation file comprises:
identifying a first platform-independent statement of the one or more platform-independent statements,
responsive to identifying the first platform-independent statement, applying a platform-specific style feature to a first graphical element,
identifying a first override statement of the one or more override statements, wherein the first override statement comprises at least a first override platform, and
responsive to identifying the first override platform as the device platform of the computing device, maintaining one or more override style features, wherein the one or more override style features are associated with a second graphical element;
interpret at least a portion of the platform-specific presentation file, wherein the platform-specific presentation file defines a portion of a graphical user interface; and
render, to a display, the graphical user interface.

31. A non-transitory computer readable medium having instructions stored thereon that, when executed, cause a processor to:
determine a device platform of a computing device;
apply a first interface style to a presentation file to determine a platform-specific presentation file, wherein:
an application installed upon the computing device comprises the presentation file,
the presentation file comprises a plurality of runtime-interpretable statements, wherein the plurality of runtime-interpretable statements comprise one or more platform-independent statements and one or more override statements, and
applying the first interface style to the presentation file comprises:
identifying a first platform-independent statement of the one or more platform-independent statements,
responsive to identifying the first platform-independent statement, applying a platform-specific style feature to a first graphical element,
identifying a first override statement of the one or more override statements, wherein the first override statement comprises at least a first override platform, and
responsive to identifying the first override platform as the device platform of the computing device, maintaining one or more override style features, wherein the one or more override style features are associated with a second graphical element;
interpret at least a portion of the platform-specific presentation file, wherein the platform-specific presentation file defines a portion of a graphical user interface; and
render, to a display, the graphical user interface.

32. A system comprising:
a processor; and
a memory storing instruction thereon, wherein the instructions when executed cause the processor to:
determine a platform of a computing device, wherein the computing device comprises the processor;
based at least in part upon the platform, alter a platform-independent presentation file; and
determine a platform-specific graphical user interface of a software application based at least in part on the platform-independent presentation file.

33. A non-transitory computer readable medium having instructions stored thereon that, when executed, cause a processor to:
determine a platform of a computing device, wherein the computing device comprises the processor;
based at least in part upon the platform, alter a platform-independent presentation file; and
determine a platform-specific graphical user interface of a software application based at least in part on the platform-independent presentation file.
